(19) United States
(12) Patent Application Publication
(10) Pub. No.: US 2008/0195938 A1
(43) Pub. Date: Aug. 14, 2008

(54) Media Content Alteration

(76) Inventors: Steven Tischer, Atlanta, GA (US); Douglas O'Neil, Marietta, GA (US); Ari Craine, Marietta, GA (US)

Correspondence Address: HOPE BALDAUFF HARTMAN, LLC, 1720 PEACHTREE STREET, N.W, SUITE 1010, ATLANTA, GA, 30309, US

(21) Appl. No.: 11/610,588

(22) Filed: Dec. 14, 2006

(51) Int. Cl. G06F 17/00

(52) U.S. Cl. 715/255

(57) ABSTRACT

Methods, systems, and computer-readable media provide for the alteration and insertion of media components within a media framework. According to implementations, a media framework is received and insertion parameters are defined for inserting a media component into the media framework. The media component to be inserted is identified and inserted into the media framework according to the insertion parameters. The insertion parameters may be retrieved from the media framework, determined using an image recognition engine, or determined from visual indicators received from the media framework. The media component to be inserted may be selected according to an identified target audience. Authorization may be required for inserting the media component according to a hierarchy of media framework distributors.

### TECHNICAL FIELD

This application relates generally to the field of media content modification. More specifically, the disclosure provided herein relates to the field of modifying components of a media framework downstream from the source of the media framework.

### BACKGROUND

People are subjected to media in many forms during everyday life. Most commonly, people spend a predictable portion of their days watching television and listening to the radio. Companies that provide products or services to consumers often spend a substantial amount of money advertising their products or services using television and radio broadcasts. In addition to paying for commercial time, which is interspersed among and interrupts the media programs, companies are increasingly paying for product placements within media programs. For example, soft drink companies will pay to have actors in a television show drink their beverages with the labels prominently displayed for the viewing audience.

Because commercials interrupt the media program in which they are included, they are easily added, removed, and manipulated within the program. For example, television shows are recorded with the knowledge that commercials will be added to the program at certain times within the program. An hour-long television show may contain only 40 minutes of programming, allowing for 20 minutes of commercial programming to be interspersed at the predetermined commercial break times. Various commercials may be inserted into these commercial breaks without having any affect on the program since the program is interrupted for the commercials. Affiliate television stations may insert local commercial broadcasts that are different from commercials inserted by other affiliate stations at other locations.

However, product placements that are recorded within the original broadcast are created as a part of the program and do not interrupt the program. Advertisements or any other media that are created as part of the program, such as a soft drink can, a billboard next to a highway, an audio promotion, or a particular television show being watched by the actors in the program, have been a fixed component of the media that is recorded and transmitted to a target audience.

### SUMMARY

Embodiments of the disclosure presented herein include methods and computer-readable media for altering and inserting media components within a media framework. According to one embodiment, a method, computer-readable medium, and system provides for receiving a media framework and defining insertion parameters for inserting a media component into the media framework. The media component for insertion is identified and inserted into the media frameworks according to the insertion parameters. Defining the insertion parameters may include identifying the dimensions and location of an area of insertion within the media framework. According to various embodiments, the insertion parameters may be retrieved from the media framework, determined using an image recognition engine, or determined from visual indicators received from the media framework.

According to another embodiment of the disclosure presented herein, a method, computer-readable medium, and system provides for altering a media component within a media framework. A media framework with multiple media components is received and authorization for replacing one or more of the media components with one or more substitute media components is determined. Parameters for replacing each authorized media component with a substitute media component are defined and the substitute media components are identified. Each authorized media component is replaced with the corresponding substitute media component according to the media component parameters.

According to yet another embodiment of the disclosure presented herein, a method, computer-readable medium, and a system provides for generating a media framework that facilitates media component modification. A media framework that includes multiple media components is received. Insertion parameters are placed within the media framework. The insertion parameters define at least one criterion for modifying the media components within the media framework.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

FIG. 1 is a block diagram showing example areas for media component alteration within a television media framework according to one embodiment presented herein;

FIG. 2 is a block diagram showing aspects of an illustrative operating environment for the disclosure presented herein;

FIG. 3 is a block diagram showing an illustrative example of a media component alteration system utilizing an image recognition engine to determine insertion parameters for inserting media components within a media stream according to one embodiment presented herein;

FIG. 4 is a block diagram showing a hierarchal media component distribution system according to one embodiment presented herein;

FIG. 5 is a flow diagram illustrating a method for inserting a media component into a media framework according to one embodiment presented herein;

FIG. 6 is a flow diagram illustrating a method for defining insertion parameters according to one embodiment presented herein; and

FIG. 7 is a flow diagram illustrating a method for inserting media components into a media framework utilizing a hierarchal distribution system according to one embodiment presented herein.

### DETAILED DESCRIPTION

The following detailed description is directed to methods, systems, and computer-readable media for inserting and altering media components within a media framework. In the following detailed description, references are made to the accompanying drawings that form a part hereof, and which are shown by way of illustration specific embodiments or examples.

As discussed briefly above, advertising within all forms of media is important to businesses as they attempt to target consumers. With the increasing popularity of digital video recorders (“DVRs”), an increasing amount of consumers are recording television shows to watch at a later time so that the commercials can be fast-forwarded, allowing for a one-hour television show to be watched in as little as 40 minutes. As a result, advertisers are increasingly interested in product placements or other advertising embedded within a media framework such as a television show that is less likely to be fast-forwarded through. According to the disclosure presented herein, embedded advertising or other media components may be altered or substituted for alternative media content. Altering or substituting embedded advertising or other media components creates alternative options for advertisers given the increasing number of viewers who are fast-forwarding through traditional commercials.

It should be understood that media frameworks may be audio, video, images, or any other type of media and may be component-based, packet-based, or any other multi-media container format. Accordingly, a media component may be a media file having any format that is associated with a media framework such that the component, if a part of the media framework as originally produced and/or transmitted, may be replaced or modified, or may alternatively be inserted into the media framework as a new component of the media framework. MPEG-4 is an example media standard that utilizes a container file format that allows for media components to be incorporated into an MPEG-4 media framework. For example, a MPEG-4 media framework may be received that includes an audio component and a JPEG image component. The audio component may be replaced with an alternative audio subcomponent, the JPEG image component may be replaced with an alternative video subcomponent, and an additional JPEG image component may be inserted into the MPEG-4 media framework that was not present when received.

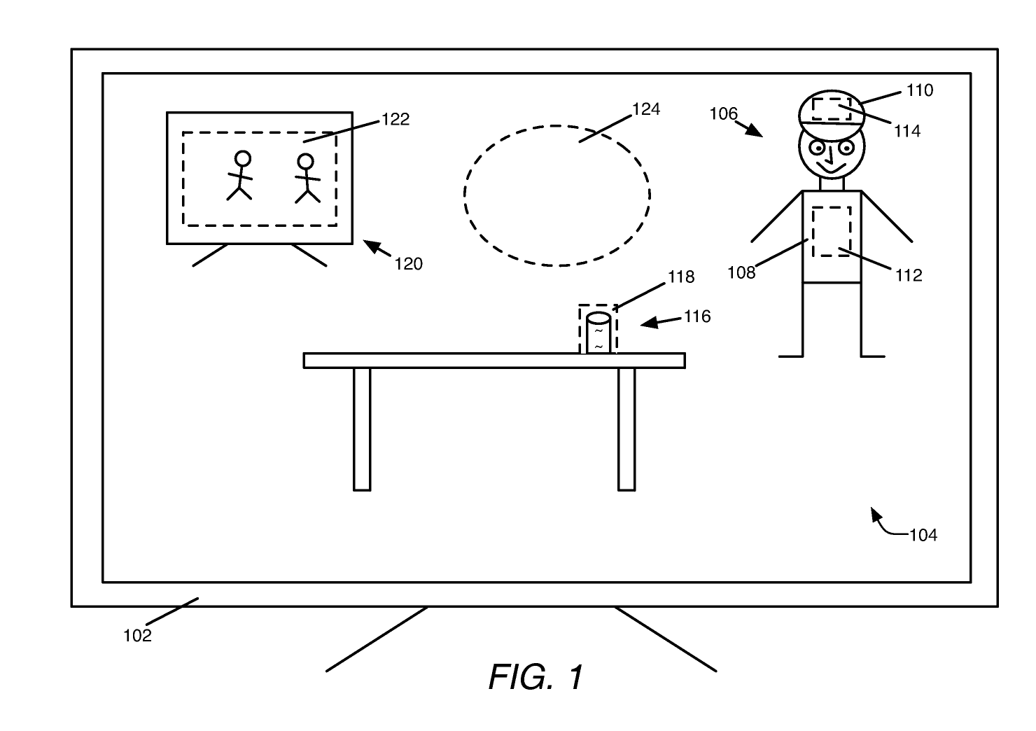

Using the disclosure presented herein, advertising space within media may be sold or auctioned to the highest bidder in substantially “real time” as the media is transmitted to a user device. Product placements in the original media stream may be substituted for alternative products or brand names. Blank spaces within media such as a wall, t-shirt, or hat may be a canvas on which advertisers may insert advertisements in the form of images or video. Referring now to the drawings, in which like numerals represent like elements through the several figures, aspects of the methods, systems, and computer-readable media provided herein will be described. FIG. 1 shows an example of various component insertion areas within a television show where the existing media components may be altered or where new media components may be inserted according to implementations provided herein. It should be understood that while the example shown in FIG. 1 utilizes a television 102 and corresponding television program 104 for illustrative purposes, the disclosure presented herein is equally applicable to any types of media and display devices.

The television program 104 is received at the television 102 as a media framework and is displayed for a viewer. The example television program 104 shown in FIG. 1 includes an actor 106 wearing a t-shirt 108 and a hat 110. A canned beverage 116 sits on a table. A television 120 in the background is displaying media, such as a television program or advertisement. Dotted lines designate media component insertion areas 112, 114, 118, 122, and 124, which represent insertion parameters within a frame of the television program 104 defining where and when media components may be inserted, altered, or replaced. It should be understood that for the purposes of this disclosure, a media component insertion area is a spatial or temporal location within a media framework at which media components may be inserted, altered, or replaced. In other words, the media component insertion areas 112, 114, 118, 122, and 124 define available “real estate” within the media framework at which existing images, video, audio, and other media may be altered or replaced, and at which new images, video, audio, and other media may be inserted.

The media component insertion areas 112, 114, 118, 122, and 124 determine the parameters for inserting media components. The parameters may include the coordinates or other indications of the boundaries encompassing the area for inserting or removing a media component, the time for insertion or removal of a media component, or a combination thereof. It should be understood that the media component insertion areas 112, 114, 118, 122, and 124 may be defined by any criteria in addition to or instead of physical boundaries. For example, the media component insertion area 124 may not be limited to the physical space outlined by the dotted line in FIG. 1. Rather, the media component insertion area 124 may be defined by the luminance, chrominance, spatial, or temporal characteristics of the media framework. It should be appreciated that as any of these characteristics change, the “boundaries” of the media component insertion area 124 may dynamically change accordingly.

The t-shirt 108 includes the media component insertion area 112 and the hat 110 includes the media component insertion area 114. As will be described in detail below, these media component insertion areas 112 and 114 include areas of sufficient dimensions to allow an advertisement or other sub-content to be effectively viewable by an audience when inserted into the television program 104 and may be identified according to tags or other metadata embedded in the media framework or image recognition technology. It should be appreciated that the media component insertion areas 112 and 114 may encompass blank text-free and image-free areas of the t-shirt 108 and the hat 110, respectively, or may include advertisements or other media components that may be removed prior to inserting new media component or that may be overwritten by the new media component.

The television program 104 also includes an image of the canned beverage 116. The media component insertion area 118 may include the entire canned beverage 116 as shown such that the entire canned beverage 116 may be replaced with a different canned beverage, a bottled beverage, or a named-brand fast-food dinner. Alternatively, the media component insertion area 118 may include only a portion of the canned beverage 116 that allows an advertisement or other media component to be inserted into the television program 104 such that it appears on the side of the canned beverage 116. Additionally, the television program 104 includes the television 120 that is displaying media, which may be a television show, a movie, a commercial, a picture, or any other known media. It should be appreciated that the media shown on the television 120 may include only video, only images, only audio, or any combination thereof. The media shown on the television 120 is a media component that may be altered or replaced. For example, according to implementations described herein, the television program 104 may include the actor 106 watching a movie that is displayed within the media component insertion area 122. The movie may be replaced with a commercial advertisement so that the actor 106 is now watching a commercial.

It should be appreciated that media component insertion areas do not have to be associated with any particular object within a media framework, as are the media component insertion areas 112, 114, 118, and 122. Rather, a media component insertion area may be defined by any available spatial or temporal absence of a media component. For example, the media component insertion area 124 is defined by a blank space that could be a portion of a wall, the sky or any available space in the background of one or more frames of a media framework when displayed for a viewer. Similarly, audio media components may be inserted into an audio media framework at any location. Various means for locating media component insertion areas will be described in detail below.

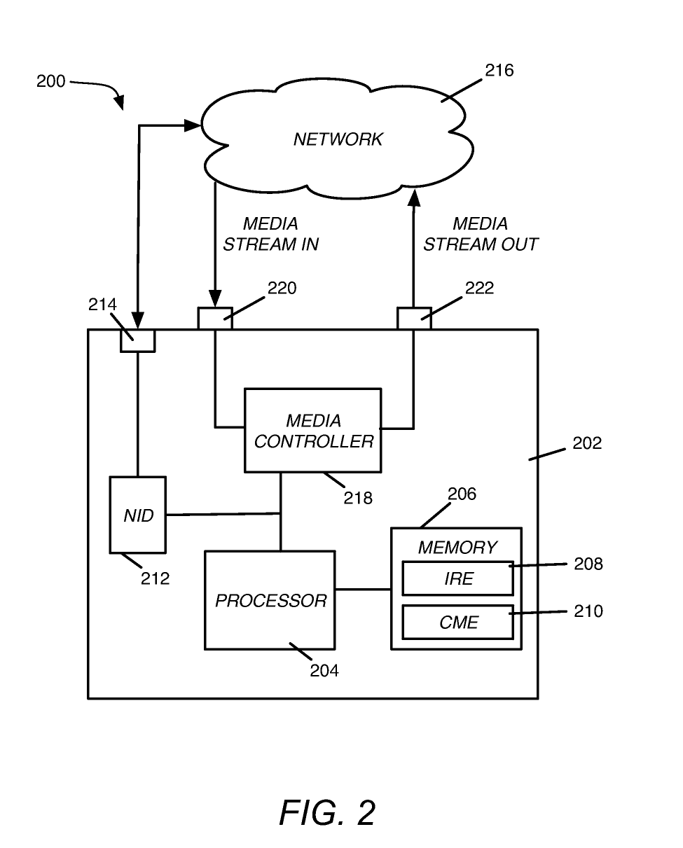

Referring to FIG. 2, an illustrative operating environment 200 according to various embodiments presented herein will be described. The environment 200 includes a computing device 202. It should be understood that the computing device 202 may be any device having a processor 204 and memory 206 capable of storing and executing a content management engine (“CME”) 210. The computing device 202 may be a server computer or may be located within an end-user device or other device such as a television, set-top box, DVR, personal computer, radio, cellular telephone, personal data assistant, video game console, or any other entertainment or communications device. The processor 204 may comprise a general purpose central processing unit (“CPU”), a more specific purpose programmable logic controller (“PLC”), a programmable gate array, or other type of processor known to those skilled in the art and suitable for controlling the operation of the computing device 202.

The processor 204 is connected to the memory 206. The memory 206 may comprise a volatile or non-volatile memory that includes program code executed by the processor 204 for controlling the operation of the computing device 202. In particular, as will be discussed in greater detail below, the memory 206 may include an image recognition engine (“IRE”) 208 that identifies media component insertion areas within media frameworks. The memory 206 additionally may include a CME 210 that receives data from various databases discussed below associated with a target audience, matches and retrieves media components for insertion into a media framework according to the target audience, and utilizes the data, the media components and the identified media component insertion areas to insert the matched media components into the media framework. It should be appreciated that the IRE 208 and the CME 210 may reside in separate computing devices 202 that are communicatively linked or may be co-located within the memory 206 of a single computing device 202 as shown. It should also be appreciated that the IRE 208 and the CME 210 may include hardware in addition to the software located within the memory 206. Additionally, as discussed below, not all implementations described herein require the IRE 208. If the media framework has tags or other metadata that identifies media component insertion areas within the framework, then the IRE 208 may not be used or present within the operating environment 200.

The processor 204 may be further connected to a network 216 via a network interface device (“NID”) 212 and network connector 214. The computing device 202 may receive media frameworks, media components, data, instructions, or other communications via a wired or wireless connection to the network 216. The network 216 may include a wireless network such as, but not limited to, a Wireless Local Area Network (“WLAN”) such as a WI-FI network, a Wireless Wide Area Network (“WWAN”), a Wireless Personal Area Network (“WPAN”) such as BLUETOOTH, a Wireless Metropolitan Area Network (“WMAN”) such a WiMAX network, a cellular network, or a satellite network. Alternatively, the network 104 may be a wired network such as, but not limited to, a wired Wide Area Network (“WAN”), a wired Local Area Network (“LAN”) such as the Ethernet, a wired Personal Area Network (“PAN”), or a wired Metropolitan Area Network (“MAN”). The network 216 may include the Internet such that the computing device 202 communicates with other devices via wireless or wired connections to the Internet. An example of Internet communications that is applicable to the disclosure presented herein is Internet Protocol Television (“IPTV”). Implementations described herein may be used to receive and alter IPTV media prior to displaying the media for a viewer.

The computing device 202 additionally includes a media controller 218 for receiving and transmitting media frameworks via a media input 220 and a media output 222. It should be understood by those with skill in the art that the media input 220 and the media output 222 may include any type of audio and video connectors and transmission methods, wired and wireless, including but not limited to RCA, S-Video, USB, registered jacks, BLUETOOTH, fiber optic, coaxial, component, and high definition multi-media interface (“HDMI”) or other encrypted or protected connectors and transmission means. It should also be appreciated that the media framework may be transmitted via Internet protocol (“IP”) such as with video over IP and voice over IP and used for IPTV. With an IP media framework, the media input 220 may be a digital subscriber line (“DSL”) or coaxial cable connector. As used herein, “media” and “media content” includes audio frameworks, video frameworks, both audio and video frameworks, static images, or any other type of content that may be presented to and sensed by a user.

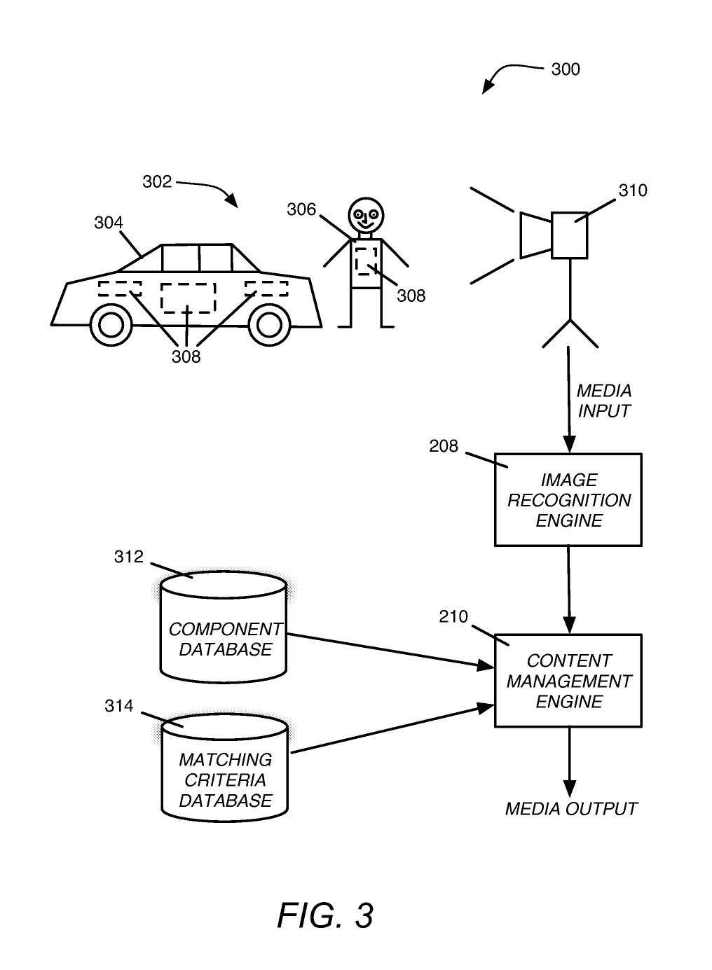

Turning now to FIG. 3, by way of illustration, the elements of a media component alteration system 300 according to one implementation will be described. The system 300 includes a camera 310 or other recording device to record a scene 302 for distribution to viewers. The scene includes a car 304 and a person 306. The car 304 has multiple media component insertion areas 308. The person 306 also has a media component insertion area 308. These media component insertion areas 308 may be identified in any one or number of methods, with or without the use of the IRE 208. One method for identifying the media component insertion areas 308 is via tags or other metadata embedded within the media framework containing the scene 302 prior to distribution. By placing tags within the media framework, the IRE 208 or the CME 210 is able to determine where and when to replace or insert media components within the media framework. The tags may identify locations for insertion of media components, may include specifications that define one or more insertion areas 308 such as size, location, and duration of display, may include pointers to substitute or additional media components that are included within the media framework or that is located on an external storage device, or any combination thereof to be recognized and acted upon by the CME 210.

A second method for identifying the media component insertion areas 308 is to utilize the IRE 208 and known techniques, such as utilizing POSTSCRIPT techniques, for recognizing objects and patterns within the media framework. For example, the IRE 208 may be programmed to recognize objects or spaces that have pre-defined amount of contiguous blank space, uniform color, and/or uniform pattern that would allow enough space for an advertisement or other media component to be inserted. Moreover, the IRE 208 may be programmed to recognize an automobile. The IRE 208 recognizes and identifies the car 304 and determines the available media component insertion areas according to pre-defined parameters. These parameters may be dependent upon any number of characteristics defined by the media component creators, such as advertisers, the media creators, the media format, the scene 302, or the end-user devices. For example, an advertisement to be placed on the shirt of the person 306 requires that the corresponding media component insertion area 308 be large enough to allow the advertisement to be seen. Therefore, the corresponding media component insertion area 308 should be of a certain dimension to accommodate the desired advertisement and/or the desired advertisement should be scalable to a certain dimension associated with a target media component insertion area 308.

It should be understood that the matching of media component insertion areas 308 to specific media components may be performed by the IRE 208, the CME 210, or a combination thereof. It should also be appreciated that the IRE 208 and the CME 210 may be the same application or the same application and hardware combination. As an example, the IRE 208 may identify media component insertion areas 308 of certain sizes, tag the media component insertion areas 308 according to the sizes and transmit that information to the CME 210, which matches media components to the tagged media component insertion areas 308. Alternatively, the IRE 208 may look for and identify a media component insertion area 308 according to the characteristics of a specific media component.

A third method for identifying the media component insertion areas 308 is to receive and interpret visual cues from the media framework. For example, the person 306 may be wearing a shirt that has a flexible display. The flexible display may include any type of visual cue that may be received and interpreted by the IRE 208 to arrive at the media component insertion area 308. The flexible display may transmit light from light emitting diodes (“LEDs”) or other light sources along the borders of a media component insertion area 308 in order for the IRE 208 to be able to identify the outer boundaries of the media component insertion area 308 and calculate the correct dimensions for the media component that will occupy the media component insertion area 308. Alternatively, the flexible clothing display may transmit light in a pattern or frequency that allows the scene 302 to communicate the insertion parameters associated with the media component insertion areas 308. It should be appreciated that the light may be visible light or non-visible light such as infrared.

The identified media component insertion areas 308 are transmitted to the CME 210. The CME 210 identifies one or more media components from a component database 312. The component database 312 is a repository for media components. The media components are indexed or otherwise tagged with descriptors within the component database 312 according to any desired characteristics to allow the CME 210 to identify a media component for insertion into a media component insertion area 308. It should be understood that the media components within the component database 312 may be personal media rather than advertisements or other commercial media. Implementations described herein allow for a user to insert personal media into a media framework. As an example, a user may have family pictures and movies stored on a DVR or other component database 312. The CME 210 may be programmed to randomly or selectively place pictures of the family on any empty wall space within a television show or movie as identified by the IRE 208.

According to another implementation, the media framework transmitted from the source may contain multiple media components for a single media component insertion area 308. The appropriate media component for insertion into the media component insertion area 308 may depend upon user input received at the CME 210, or may be determined according to pre-programmed instructions executed by the CME as the result of detecting a particular trigger or criteria being satisfied. The media components may be simple advertisements placed into a scene 302 as shown, or may be entire substitute portions of the media framework. Upon input from a user or detection of the appropriate trigger, a media component is selected from a group of media components and is inserted into the media framework by the CME 210.

The CME 210 additionally receives data from a matching criteria database 314. It should be appreciated that the matching criteria database 314 and the component database 312 may be co-located, located in separate remote locations, or may be the same database. The matching criteria database 314 contains any data corresponding to a target audience for which the media components are being added to the media framework. For example, the matching criteria database 314 may include target audience demographic data associated with a geographic location. In this manner, advertisements may be inserted into the media framework that are targeted to the specific audience demographic associated with the location to which the media framework is being transmitted. Similarly, the matching criteria database 314 may contain data corresponding to specific subscribers. Subscribers to a service providing implementations described herein may maintain a subscriber profile that includes information pertaining to the subscriber's devices to which the media framework will be sent. The media components selected by the CME 210 for insertion into the media framework may depend upon the characteristics of the end user device such as display size and quality, memory, and audio capabilities.

The subscriber profile may also contain information pertaining to the purchasing habits of the subscriber. This information may be input into the subscriber profile, or the subscriber profile may be automatically populated with this information from the businesses from which purchases were made or from credit card companies corresponding to the credit card used by the subscriber. Purchasing information may allow for more effective targeted advertisements to be inserted within the media framework by the CME 210. Once the CME 210 has matched media components to the media component insertion areas 308 identified by the IRE 208 or tagged within the media framework, then the CME 210 formats the matched media components according to the insertion parameters determined as described above. For example, if the IRE 208 determines through one of the methods described above that the media component insertion area 308 has specific dimensions at specific coordinates within the media framework at a specific time, then the CME 210 must size the matched media component according to those parameters prior to insertion into the media framework. After formatting, the CME 210 inserts the matched media components into the media component insertion areas 308 and transmits the media framework to the end user or the next media distributor.

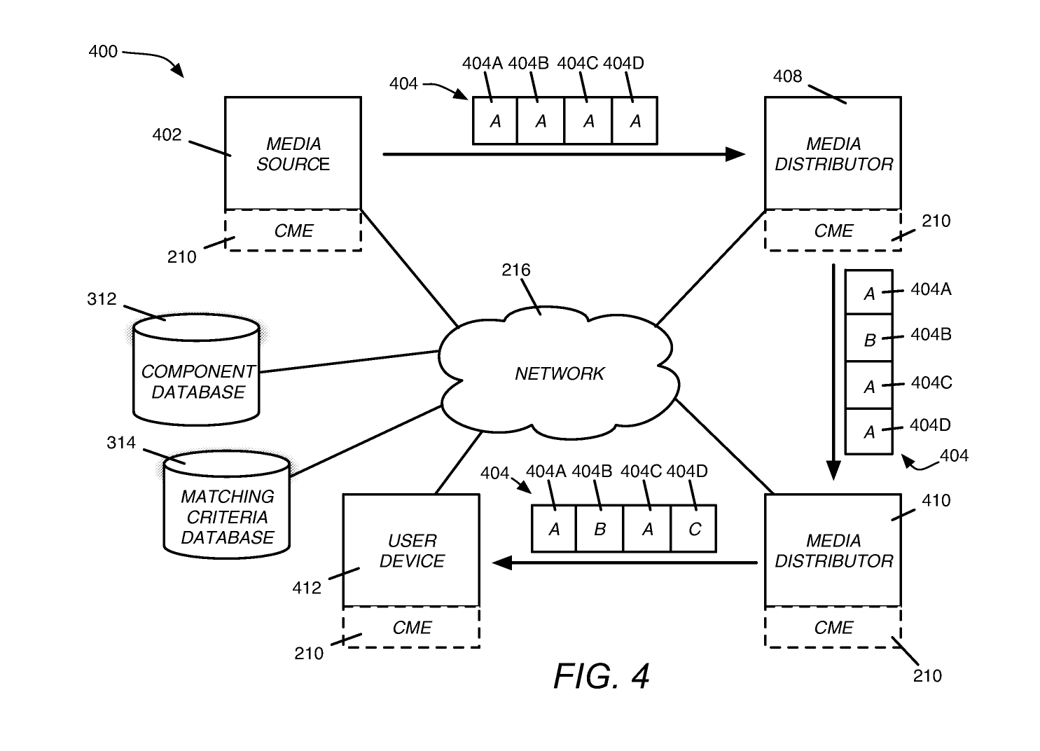

FIG. 4 shows a hierarchal media component distribution system 400 according to one embodiment presented herein. The media distribution system 400 illustrates how media components may be altered during the distribution of a media framework 404 from a media source 402 to a user device 412. The media framework 404 originates at the media source 402 and is transmitted to a media distributor 408. From the media distributor 408, the media framework is sent to another media distributor 410 and finally to the user device 412. As an example, a television show is created at a source and distributed through multiple levels of distributors as it finally is transmitted to a home via a local broadcast station. For clarity, only the media source 402 and two media distributors 408 and 410 are shown, but it should be understood that any number of distributors or other elements may be included between the media source 402 and the user device 412. The media framework 404 and all communications between elements within the media distribution system 400 may be transmitted and received via the network 216. As stated above with respect to FIG. 2, the network 216 may include a wireless network such as, but not limited to, a WLAN such as a WI-FI network, a WWAN, a WPAN such as BLUETOOTH, a WMAN such a WiMAX network, a cellular network, or a satellite network. Alternatively, the network 216 may be a wired network such as, but not limited to, a wired WAN, a wired LAN such as the Ethernet, a wired PAN, or a wired MAN. The network 216 may include the Internet such that the elements of the media distribution system 400 communicate via wireless or wired connections to the Internet.

According to one implementation, the media source 402 creates the media framework 404. Within the media framework 404, there are four media component insertion areas 404A-404D. It should be appreciated that although only four media component insertion areas 404A-404D are shown, any number of media component insertion areas may be identified within the media framework 404. The media component insertion areas 404A-404D may be identified using any of the methods described above, with or without an IRE 208. Because the media framework contains four identified media component insertion areas 404A-404D, the media source 402 inserts four media components utilizing the CME 210 and data from the component database 312 and the matching criteria database 314. It should be understood that the CME 210 may be located at one or all of the elements 402, 408, 410, and 412, or may reside in a separate server communicatively linked to the network 216. For simplicity, the four media components inserted into the four media component insertion areas 404A-404D by the media source 402 are labeled as “A” as if they are an advertisement A for advertiser A. Similarly, labels “B” and “C” are given to advertisements B and C from advertisers B and C respectively. According to one embodiment, the advertiser A may have paid for one advertisement A to be inserted into the media framework 404. For illustrative purposes, this advertisement A is placed into the media component insertion area 404A. However, being the first component within the media distribution system 400 at which media components may be inserted, the media source 402 may wish to insert advertisement A into the remainder of the identified media component insertion areas 404B-404D on the chance that the other media component insertion areas 404B-404D are not sold, giving advertiser A free advertisements.

The media framework 404 is transmitted to the media distributor 408 with advertisement A inserted into the media component insertion areas 404A-404D. The media distributor 408 may have permission to fill one of the four media component insertion areas 404A-404D. Because the media component insertion area 404A was purchased by advertiser A, the media distributor 408 may fill any one of the remaining three media component insertion areas 404B-404D. The media distributor 408 replaces the advertisement A in the media component insertion area 404B with an advertisement B and transmits the modified media framework 404 to the media distributor 410. The media distributor 410 may also have permission to fill one of the four media component insertion areas 404A-404D. Because the media component insertion areas 404A and 404B were purchased by advertisers A and B respectively, the media distributor 410 may fill either of the remaining two media component insertion areas 404C or 404D. The media distributor 410 replaces the advertisement A in the media component insertion area 404D with an advertisement C and transmits the modified media framework 404 to the user device 412 for playback. The user device may further insert a media component into the remaining media component insertion area 404C.

Alternatively, the media component insertion area 404C may remain filled with the advertisement A, giving the advertiser A a free advertisement. It should be appreciated that the media distributor 408 may have replaced advertisements A within the media component insertion areas 404C and 404D with advertisements B in hopes of providing advertiser B with free advertisements should those media component insertion areas 404C and 404D go unfilled downstream depending on hierarchal rules for media sub-content insertion. According to one implementation, hierarchal rules establish the permission that an element of the media distribution system 400 is given for inserting media components into the media framework 404. High priority elements of the media distribution system 400 may have permission to override other elements within the media distribution system 400 that have a lower priority.

Additionally, each media component insertion area 404A-404D may be filled with a different media component at each element of the media distribution system 400 according to any number of factors within the matching criteria database 314 and utilized by the CME 210. For example, the media distributor 410 may represent one of a number of local television network affiliates. Each local affiliate may fill the media component insertion area 404D with a different advertisement according to the geography data and viewer demographic data stored in the matching criteria database 314. Moreover, a single media distributor 410 may insert media sub-content into the media component insertion area 404D that is specifically targeted to individual households according to data, such as purchase history data, collected and stored in the matching criteria database 314.

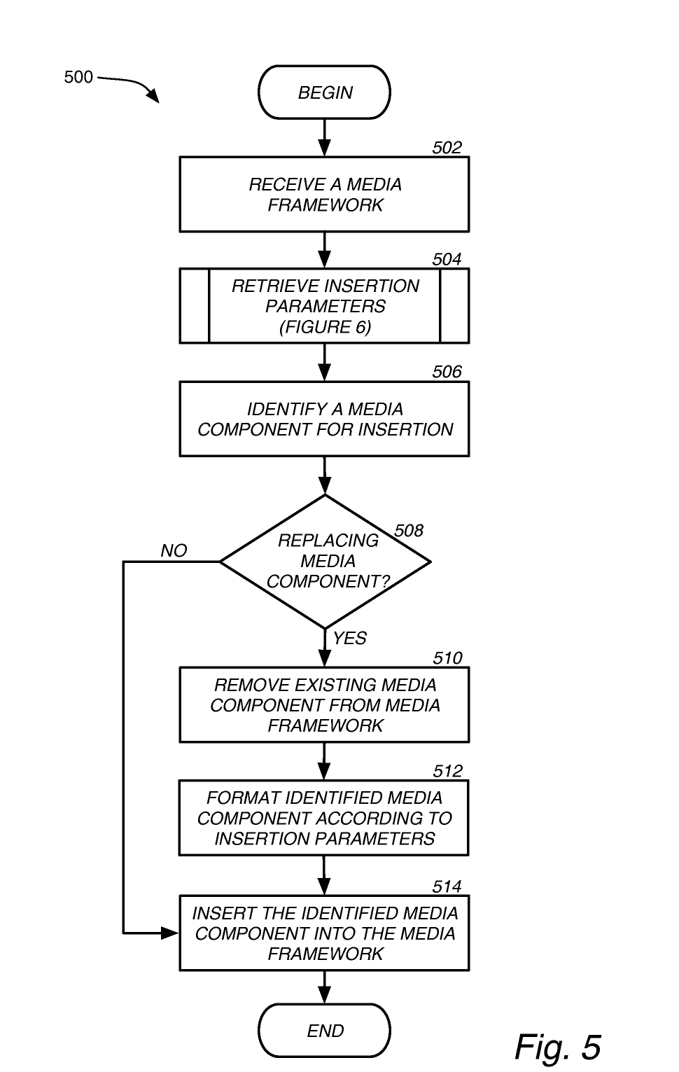

Referring now to FIG. 5, an illustrative routine 500 will be described for inserting a media component into a media framework according to one embodiment presented herein. It should be appreciated that the logical operations described herein may be implemented (1) as a sequence of computer implemented acts or program modules running on a computing system and/or (2) as interconnected machine logic circuits or circuit modules within the computing system. The implementation is a matter of choice dependent on the performance requirements of the computing system. Accordingly, the logical operations described herein are referred to variously as operations, structural devices, acts, or modules. These operations, structural devices, acts and modules may be implemented in software, in firmware, in special purpose digital logic, and any combination.

The routine 500 begins at operation 502, where a media framework is received at the computing device 202. It should be understood that some operations will be described herein as being performed by the computing device 202. The computing device 202 includes the IRE 208 and the CME 210. As described above, the IRE 208 and the CME 210 may each perform various aspects of the embodiments described herein or may be a single engine that performs all of the embodiments described herein. Additionally, as described above, the IRE 208 and the CME 210 may reside on a single computing device 202, or on separate computing devices.

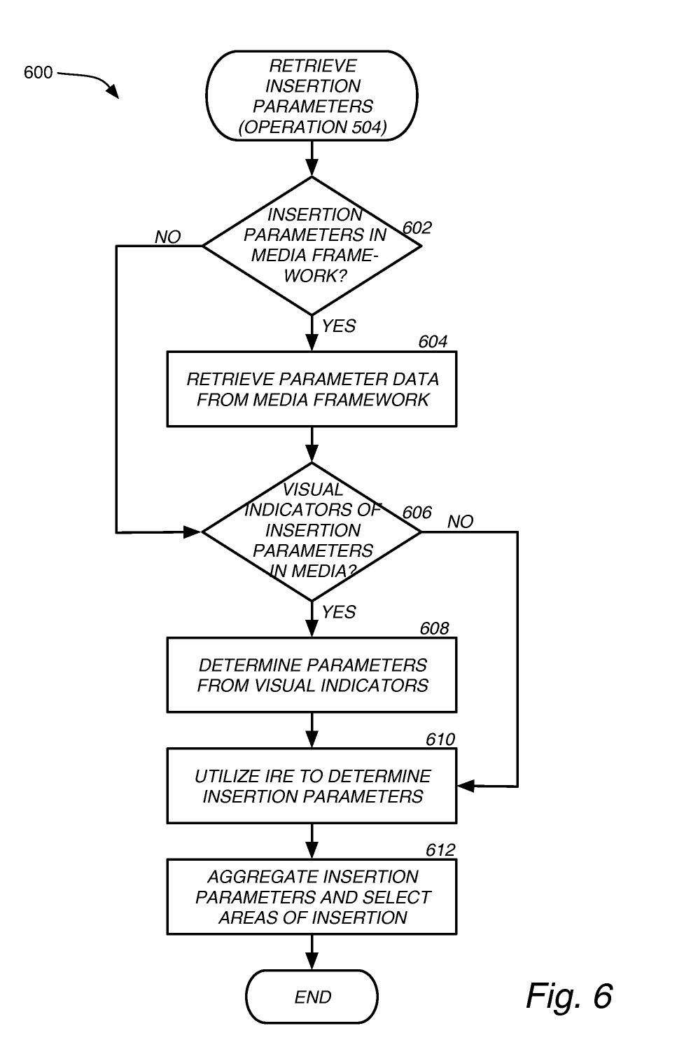

From operation 502, the routine 500 proceeds to operation 504, where the computing device 202 retrieves insertion parameters for inserting media components into the media framework. This operation is further defined in FIG. 6 and will be discussed in detail below. The routine 500 continues from operation 504 to operation 506, where the CME 210 identifies a media component for insertion into the media framework. As discussed above, the media components may be embedded within the media framework or may be stored in the component database 312. The media components may be identified according to criteria stored within the matching criteria database 314. Among other information, these criteria may include demographic data associated with the target audience, specific data corresponding to subscribers such as purchase history and personal preferences, and data corresponding to the end-user devices on which the media framework will be visually or audibly presented to the user.

The routine 500 continues from operation 506 to operation 508, where the CME 210 makes a determination as to whether a media component is being replaced. If a media component is not being replaced, then the routine 500 proceeds to operation 514, where the CME 210 inserts the identified media component into the media framework and the routine 500 ends. If, however, at operation 508, the CME 210 determines that a media component is being replaced, then the routine 500 proceeds to operation 510, where the CME 210 removes the existing media component from the media framework. It should be appreciated that when the existing media component is not formatted in a container file format such that it may be easily removed from the media framework, then the CME 210 may insert the identified media component over the existing media component. From operation 510, the routine 500 continues to operation 512, where the CME 210 formats the identified media component according to the defined insertion parameters. The routine 500 continues to operation 514, where the CME 210 inserts the identified media component into the media framework and the routine 500 ends.

FIG. 6 shows an illustrative routine 600 for retrieving insertion parameters according to various embodiments presented herein. The routine 600 begins at operation 602, where the computing device 202 determines whether insertion parameters are included within the received media framework. As described above, the media framework may include tags that define the insertion parameters. If the insertion parameters are not included within the media framework, then the routine 600 proceeds to operation 606. If, however, the insertion parameters are included within the media framework, then the routine 600 continues to operation 604, where the computing device 202 retrieves the insertion parameter data from the media framework. From operation 604, the routine 600 continues to operation 606, where the computing device 202 determines whether visual indicators of the insertion parameters are included within the media framework. As described above, the visual indicators may be cues in the form of light being transmitted according to a frequency or pattern corresponding to the insertion parameters or transmitted at the boundaries of a media component insertion area.

If the computing device 202 determines that visual indicators of the insertion parameters are not included within the media framework, then the routine 600 proceeds to operation 610. However, if the computing device 202 determines that the media framework includes insertion parameters in the form of visual indicators, then the routine 600 continues to operation 608, where the computing device 202 determines the insertion parameters from the visual indicators. From operation 608, the routine 600 continues to operation 610, where the IRE 208 determines any additional insertion parameters by using image recognition to define media component insertion areas. The routine continues to operation 612, where the various insertion parameters determined from tags within the media framework, from visual indicators within the media framework, and from image recognition are aggregated by the computing device 202 as the available media component insertion areas and the routine 600 ends. It should be understood that the computing device 202 might define the insertion parameters according to any single method described or combination of methods.

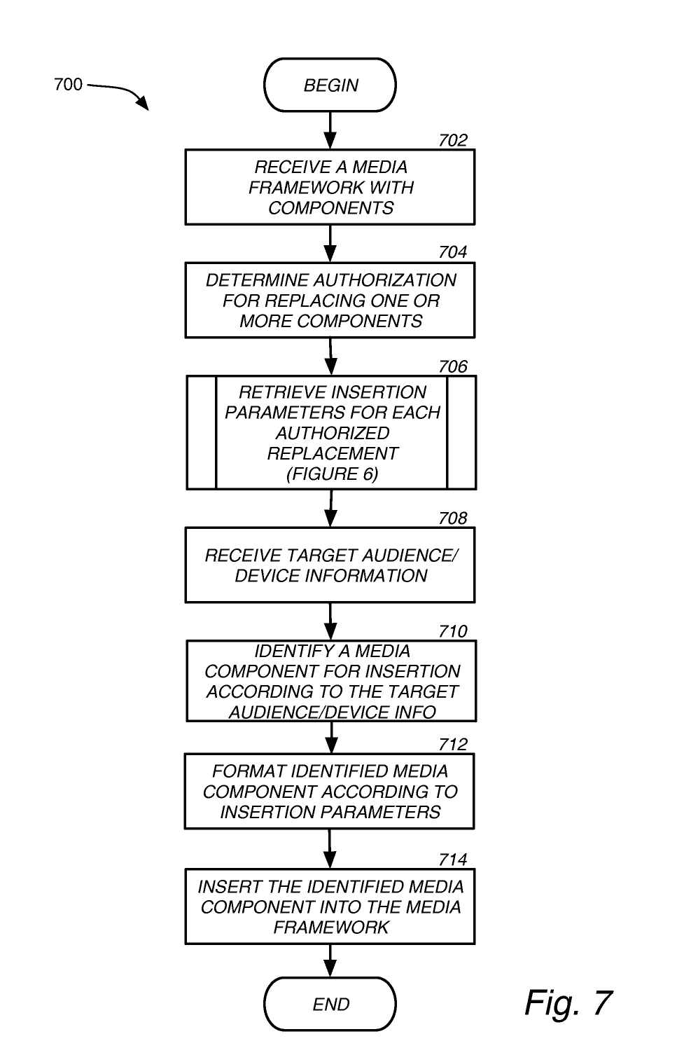

Turning to FIG. 7, an illustrative routine 700 for inserting media components into a media framework utilizing a hierarchal distribution system will be described. The routine 700 begins at operation 702, where the computing device 202 receives a media framework that includes components. At operation 704, the computing device 202 determines authorizations for replacing one or more components. As discussed above, each element of a media distribution system 400 may have permission to replace or insert media components into the media framework according to a hierarchy of media distribution system elements. From operation 704, the routine 700 continues to operation 706, where the insertion parameters for each authorized component replacement are defined by the computing device 202 according to the process described with respect to FIG. 6.

The routine 700 proceeds from operation 706 to operation 708, where the CME 210 receives target audience and/or device information associated with the target audience for each authorized replacement. As discussed above, this information may include demographic information, specific subscriber information from a subscriber profile, geographic location information, and end-user device information. From operation 708, the routine 700 continues to operation 710, where the CME 210 identifies a media component for each authorized replacement for insertion into the media framework according to the target audience and/or device information. The routine 700 proceeds to operation 712, where the CME 210 formats the identified media components for insertion into the media framework according to the defined insertion parameters. From operation 712, the routine 700 continues to operation 714, where the CME 210 inserts the identified media components into the media framework according to the defined insertion parameters and the routine 700 ends.

Although the subject matter presented herein has been described in conjunction with one or more particular embodiments and implementations, it is to be understood that the invention defined in the appended claims is not necessarily limited to the specific structure, configuration, or functionality described herein. Rather, the specific structure, configuration, and functionality are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A method for inserting a media component into a media framework, comprising:
receiving the media framework;
retrieving insertion parameters for inserting the media component into the media framework;
identifying the media component for insertion into the media framework; and
inserting the identified media component into the media framework according to the insertion parameters.

2. The method of claim 1, wherein the insertion parameters identify the dimensions and location of an area of insertion within the media framework, and wherein inserting the media component into the media framework comprises formatting the media component according to the defined parameters and inserting the media component into the media framework at the identified area of insertion.

3. The method of claim 2, wherein inserting the media component into the media framework according to the insertion parameters comprises removing an existing media component from the identified area of insertion prior to inserting the identified media component.

4. The method of claim 2, wherein retrieving the dimensions and location of the area of insertion within the media framework comprises retrieving the insertion parameters from the media framework.

5. The method of claim 2, wherein retrieving the dimensions and location of the area of insertion within the media framework comprises utilizing an image recognition engine to determine the dimensions and location of the area of insertion.

6. The method of claim 5, wherein determining the dimensions and location of the area of insertion comprises recognizing a target object within the frame and determining a dimensions and location of a portion of the target object having a solid, uniform color.

7. The method of claim 2, wherein retrieving the dimensions and location of the area of insertion within the media framework comprises receiving a visual indicator within the media framework to determine the dimensions and location of the area of insertion.

8. The method of claim 7, wherein the media framework comprises a visual representation of a flexible clothing display, wherein the flexible clothing display transmits the visual indicator corresponding to the dimensions and location of the flexible clothing display within at least one frame of the media framework.

9. The method of claim 1, wherein identifying the media component for insertion into the media framework comprises selecting the media component according to subscriber information stored within a subscriber profile database.

10. The method of claim 1, further comprising determining a location of a playback device, and wherein identifying the media component for insertion into the media framework comprises selecting the media component according to the location of the playback device.

11. A computer-readable medium having computer-executable instructions stored thereon which, when executed by a computer, cause the computer to:
receive a media framework comprising an identified insertion location for inserting a media component;
determine a target audience;
select the media component for insertion into the media framework according to the target audience; and
insert the media component into the identified insertion location.

12. The computer-readable medium of claim 11, wherein the media framework comprises a plurality of media components from which the inserted media component is selected.

13. The computer-readable medium of claim 11, wherein causing the computer to determine the target audience comprises causing the computer to reference subscriber preference information stored in a subscriber profile.

14. The computer-readable medium of claim 11, wherein causing the computer to determine the target audience comprises causing the computer to determine the target audience according to geographic location into which the media framework is targeted.

15. The computer-readable medium of claim 11, wherein causing the computer to receive the media framework comprising the identified insertion location for inserting the media component comprises causing the computer to receive the media framework, and utilize an image recognition engine to identify the insertion location for inserting the media component.

16. A system for inserting a media component into a media framework, comprising:
means for receiving the media framework;
means for retrieving insertion parameters for inserting the media component into the media framework;
means for identifying the media component for insertion into the media framework; and
means for inserting the media component into the media framework according to the insertion parameters.

17. A method for altering a media component within a media framework, comprising:
receiving the media framework comprising a plurality of media components;
determining authorization for replacing one or more media components within the media framework with one or more substitute media components;
defining media component parameters for replacing each authorized media component with a substitute media component;
identifying the substitute media component corresponding to each authorized media component replacement for insertion into the media framework; and
replacing each authorized media component with the substitute media component according to the media component parameters.

18. The method of claim 17, wherein the plurality of media components comprises a plurality of advertisements, and wherein determining authorization for replacing one or more of the advertisements comprises determining advertisement replacement permission according to a hierarchy of distributors of the media framework.

19. The method of claim 17, wherein identifying the substitute media component corresponding to each authorized media component replacement for insertion into the media framework comprises selecting the substitute media component according to subscriber information stored within a subscriber profile database.

20. The method of claim 17, further comprising determining a location of a playback device, and wherein identifying the substitute media component corresponding to each authorized media component replacement for insertion into the media framework comprises selecting the substitute media component according to the location of the playback device.

21. A computer-readable medium having computer-executable instructions stored thereon which, when executed by a computer, cause the computer to:
receive a media framework comprising a plurality of media components;
determine authorization for replacing one or more media components within the media framework with one or more substitute media components;
define media component parameters for replacing each authorized media component with a substitute media component;
identify the substitute media component corresponding to each authorized media component replacement for insertion into the media framework; and
replace each authorized media component with the substitute media component according to the media component parameters.

22. A system for altering a media component within a media framework, comprising:
means for receiving the media framework comprising a plurality of media components;
means for determining authorization for replacing one or more media components within the media framework with one or more substitute media components;
means for defining media component parameters for replacing each authorized media component with a substitute media component;
means for identifying the substitute media component corresponding to each authorized media component replacement for insertion into the media framework; and
means for replacing each authorized media component with the substitute media component according to the media component parameters.

23. A method for generating a media framework that facilitates media component modification, comprising:
receiving a media framework characterized by a plurality of media components; and
placing insertion parameters within the media framework that define at least one criterion for modifying the plurality of media components.

24. A computer-readable medium having computer-executable instructions stored thereon which, when executed by a computer, cause the computer to:
receive a media framework characterized by a plurality of media components; and
place insertion parameters within the media framework that define at least one criterion for modifying the plurality of media components.

25. A system for generating a media framework that facilitates media component modification, comprising:
means for receiving a media framework characterized by a plurality of media components; and
means for placing insertion parameters within the media framework that define at least one criterion for modifying the plurality of media components.
